(19) United States
(12) Patent Application Publication
(10) Pub. No.: US 2006/0127650 A1
(43) Pub. Date: Jun. 15, 2006

(54) Decorative structure for patterned decorations

(76) Inventor: Chieh-Po Wang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/010,356

(22) Filed: Dec. 14, 2004

(51) Int. Cl. B44C 1/17

(52) U.S. Cl. 428/195.1

(57) ABSTRACT

The invention relates to a decorative structure for patterned decorations, which includes a semi-transparent decorative layer for covering on any patterned decorations. The decorative layer is made of paper and can be provided with any colorful figure thereon. The decorations thus obtain novel and special outlook that improve the decorative effect.

### FIELD OF THE INVENTION

The present invention relates to patterned decorations, which are provided with specific colorful semi-transparent layers outsides that will obtain novel and visual beauty for increasing decorative effect.

### BACKGROUND OF THE INVENTION

A conventional patterned decoration usually has a special outlook to show its decorative effect. Moreover, it is coated or sprayed by colorful coating to improve its visual feeling. Or, the patterned decoration is made of colorful material at the beginning. It is found that the said decorations are lack of invented spirit and are always monotonous. It is inconvenient in manufacturing procedures neither.

### SUMMARY OF THE INVENTION

The present invention is to provide a new decoration to display a beautiful outlook that has not been seen ever. Now, accompanying with the following drawings, the character of the present invention will be described here and after.

### BRIEF DESCRIPTION OF THE DRAWINGS

FIG. 1 is a perspective view showing a semi-transparent decorative layer according to the present invention.

FIG. 2 is a perspective view of FIG. 1 showing decorative layer being printed with several colorful round areas thereon.

FIG. 3 is a perspective view showing a photo-frame as a decoration.

FIG. 4 is a perspective view of FIG. 3 showing the decoration being covered with the decorative layer according to the present invention.

FIG. 5 is a front perspective view of FIG. 4.

FIG. 6 is a perspective view of FIG. 5 showing a photograph being taken out.

FIG. 7 is a perspective view showing a lamp shield as a decoration.

FIG. 8 is a perspective view of FIG. 7 showing the decoration being covered with the decorative layer according to the present invention.

FIG. 9 is a perspective view showing a dish as a decoration.

FIG. 10 is a perspective view of FIG. 9 showing the decoration being covered with the decorative layer according to the present invention.

### DETAILED DESCRIPTION OF THE PREFERRED EMBODIMENT

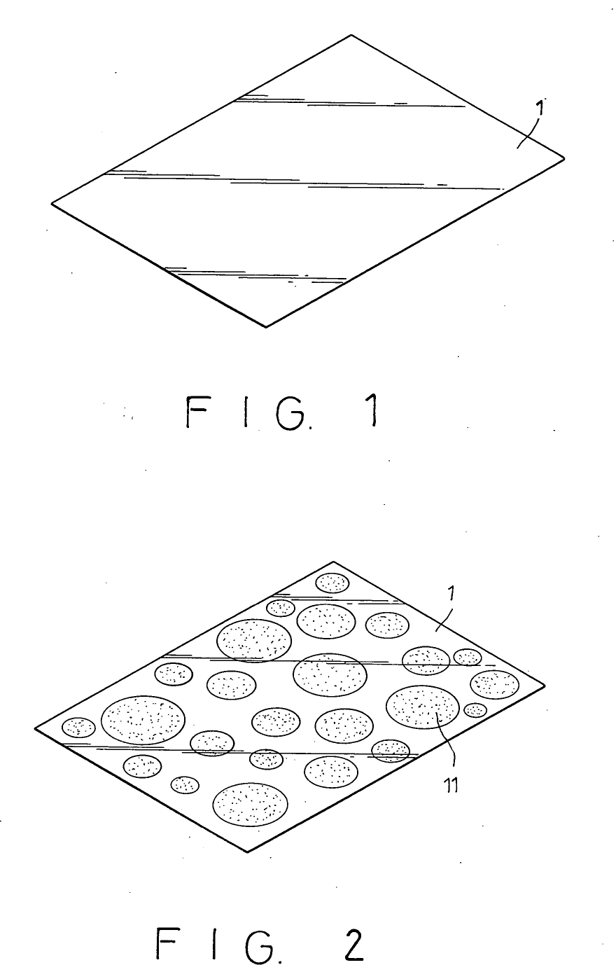

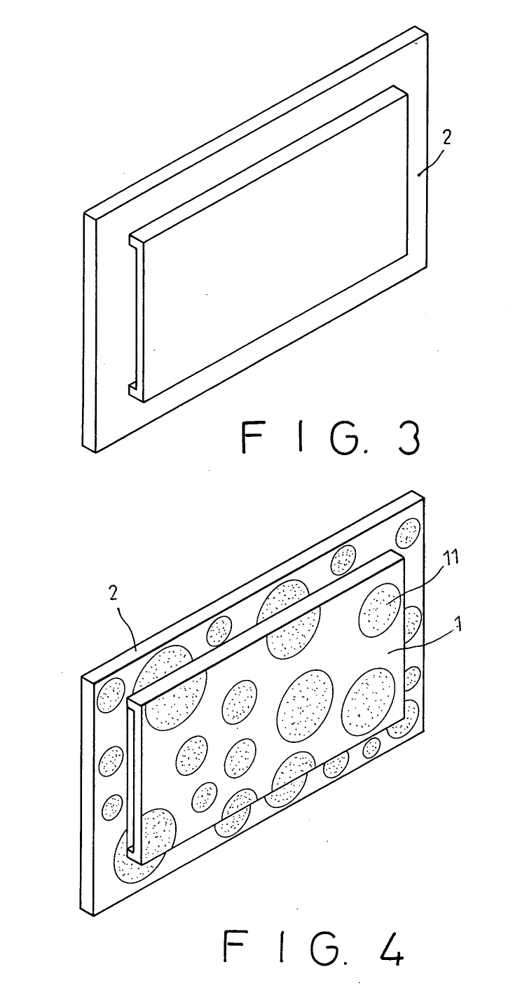

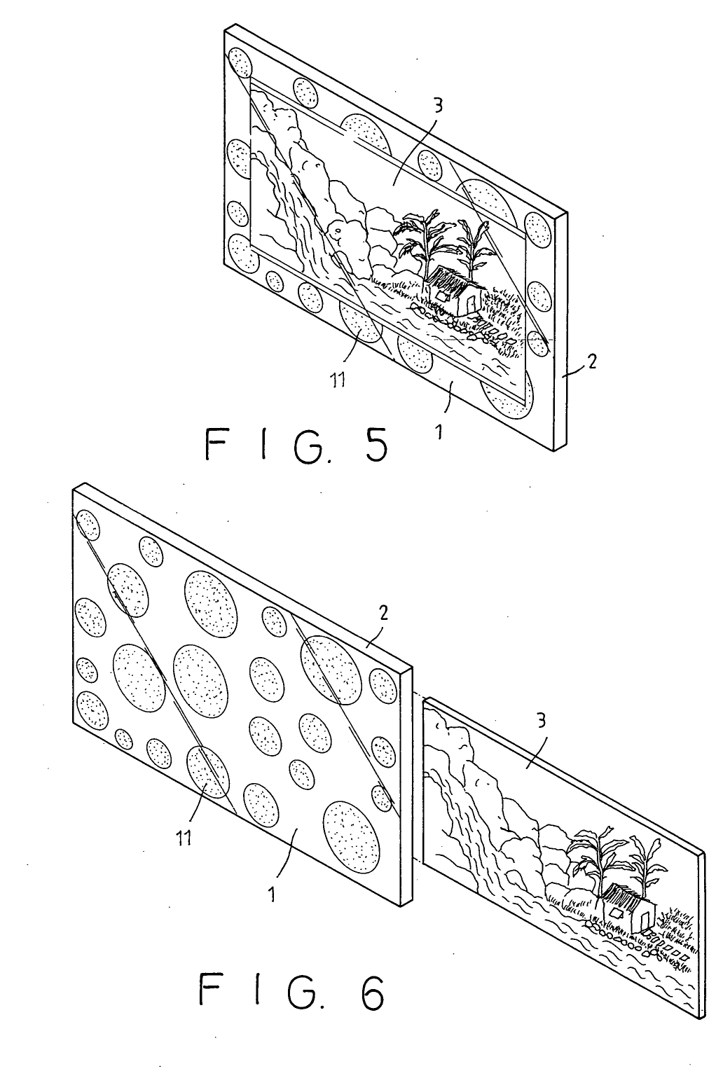

Please refer to FIG. 1, the present invention mainly provides a decorative layer (1), which is made of paper and is semi-transparent. The decorative layer (1) can be provided with any colorful figure (11) or veins thereon and is still semi-transparent, as shown in FIG. 1. A first embodiment of the present invention is shown in FIG. 3 to 6. The decoration in FIG. 3 is a transparent photo-frame (2) as a conventional one with no any specialty. As shown in FIG. 4, the present invention uses the decorative layer (1) covering on both surfaces of the frame (2). By use of the character of the decorative layer (1), the frame (2) displays different features between a photograph (3) therein (shown in FIG. 5) and the photograph (3) taken out (shown in FIG. 6). Hence, the decoration of photo-frame obtains an improved decorative effect.

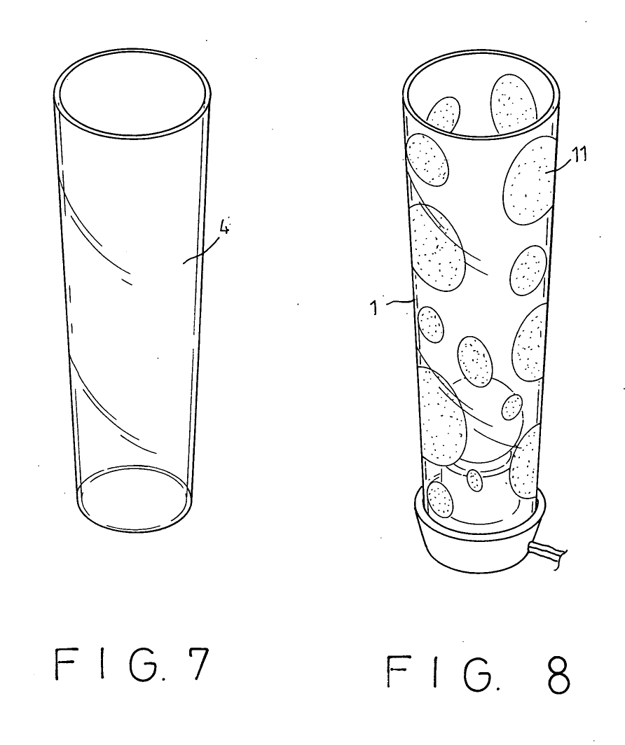

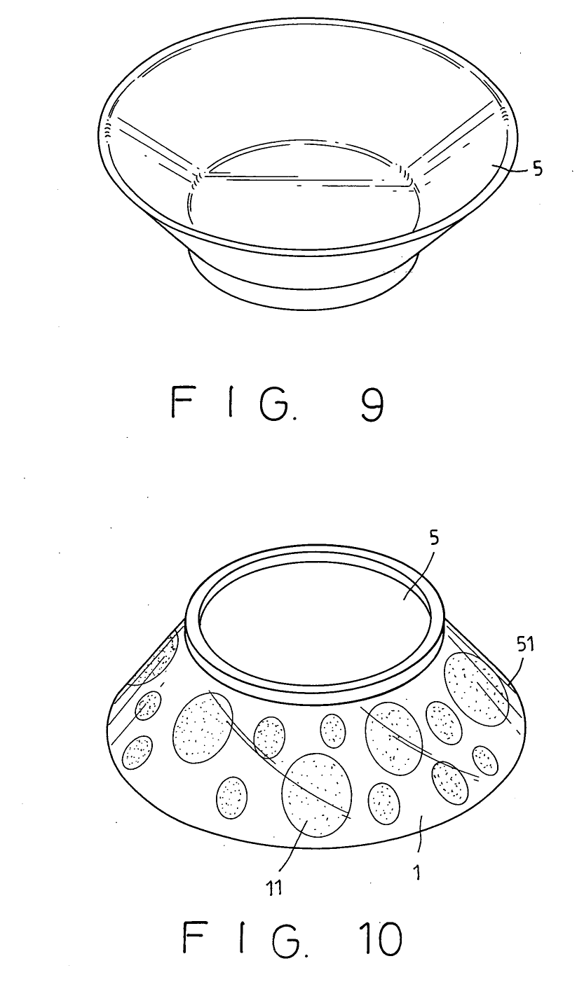

In another embodiment, as shown in FIG. 7 and 8, it shows a lamp shield (4) as a patterned decoration, which is covered with the decorative layer (1) of the present invention. This structure can provide its unique decorative effect whenever it is lightened on or not. As shown in FIG. 9, it is a normal dish (5). The dish (5) can display its special outlook after being covered with the decorative layer (1) obviously shown in FIG. 10. Moreover, since the layer (1) is made of paper, it can be formed some folded portions on any patterned decoration, such as portions (51) in FIG. 10, that provides a better feeling in touching.

I claim:

1. A decorative structure for patterned decorations including a semi-transparent decorative layer being made of paper, which can be provided with colorful figures thereon and is covered on the patterned decorations.

2. A decorative structure for patterned decorations as claimed in claim 1, wherein the decorative layer includes some folded portions on the patterned decorations.
